(19) United States
(12) Patent Application Publication
(10) Pub. No.: US 2006/0179080 A1
(43) Pub. Date: Aug. 10, 2006

(54) System for management of source and derivative data

(76) Inventors: Brian Gunnar Meek, Soquel, CA (US); George W. Coleman, Loganville, GA (US); Lyman Porter Hurd, Sandy Springs, GA (US)

Correspondence Address: GLENN PATENT GROUP, 3475 EDISON WAY, SUITE L, MENLO PARK, CA, 94025, US

(21) Appl. No.: 11/334,183

(22) Filed: Jan. 17, 2006

Related U.S. Application Data
(63) Continuation-in-part of application No. 10/438,798, filed on May 15, 2003.
Application No. 10/438,798 is a continuation of application No. 09/651,594, filed on Aug. 30, 2000, now abandoned.
(60) Provisional application No. 60/151,508, filed on Aug. 30, 1999.

(51) Int. Cl. G06F 17/30

(52) U.S. Cl. 707/200

(57) ABSTRACT

Source data is centralized in a database and derivative data sets are formed from the source data. When it is desired to modify derivative data, the source data can be accessed and modified to form a new derivative data set, instead of modifying the prior data set, such that source data integrity is maintained. Tags are associated with derivative data, which can be embedded in the derivative data or associated with the derivative data as an attached element. Tags identify information such as the server that generated the derivative data, the source data and any tasks or transformations that were applied to the source data to generate the derivative data. Users with assigned access privileges to source data can be given access to a source data repository, whereby a number of users can access the source files and modify derivative data files by changes in the source data file.

### CROSS-REFERENCE TO RELATED APPLICATIONS

This application is a Continuation in Part of and claims priority for commonly disclosed matter from INWO0035C, U.S. application Ser. No. 10/438,798, filed 15 May 2003, entitled Management of Source and Derivative Image Data which claims priority to and is a Continuation Application of U.S. application Ser. No. 09/651,594, filed Aug. 30, 2000, entitled Data Management, now abandoned, which claims priority to U.S. Provisional Application No. 60/151,508, filed Aug. 30, 1999, entitled Method and Apparatus for Managing Derivative Image Data, each of which are incorporated herein in its entirety by this reference thereto.

### BACKGROUND OF THE INVENTION

1. Field of the Invention

The invention relates generally to the management of source and derivative data and, more particularly, to methods and apparatuses for managing source and derivative image data for efficient use and manipulation within a computer network environment.

2. Discussion of the Prior Art

The Internet is the largest network of computers. Large corporations and educational institutions may have their own networks of computers, which may themselves be part of, or apart from, the Internet. Digital data, stored on one or more computers (called source data), may be accessed by one or more other computers and altered by such other computer(s) to generate derivative data. Often times, the source data are typically modified by a computer other than the computer that is requesting the derivative data. The derivative data may be stored on one or more other computers, which may include all or some of the computers on which the source data were stored and all or some of the computers that altered the source data. When the source data are representative of an image, they are called source image data and the altered data are called derivative image data.

There are many well-known methods of creating derivative image data (“DID”) from source image data (“SID”). Many of these methods consist of applying one or more transformations, T(1), T(2), . . . T(n) to the SID. These transformations may act on one or more SID sets and produce one or more DID sets. For example, if the SID is a digital image with an even number of pixels in each row and an even number of rows, T(1) may be a transformation that crops the source image to create a new image consisting of the upper right hand quarter of the source image. If the SID is a digital image where each pixel consists of three 8-bit numbers, R, B, G, that indicate the red, blue, and green intensity values, respectively, for each pixel, T(2) may be a transformation which interchanges the R and B intensity values. A derivative image may be created from a source image by performing T(1) and then T(2) and then T(1) on the SID. Other examples of image transformations are the rotation, scaling, filtering, and image processing operations contained in Adobe's Photoshop® software. Such methods are known as deterministically computable methods. Such methods generate a DID set from a specific set of SID sets by applying a specific set of completely defined transformations in a specific order. For example, if the SID set consisted of numbers and a transformation S was to multiply every other number by a random number generated by the local computer, then this method would not be deterministically computable unless the method of computing the random number was also specified and reproducible.

There are many standard and proprietary formats for image data. Some data formats do not contain information that describes how the data are to be interpreted. For example, consider a data set D consisting of 512×512×8 bits of data. This data set D may represent a gray scale image with 256 gray levels at each of the 512×512 pixel sites or the same data set D may represent balances in bank accounts. Other formats of data include meta-data, that is data about the data, that enables proper interpretation of the data. For example, there may be a header (another data set) which is appended to the header of D, which is text and reads “the data following this text consists of 512×512 bytes of data, each byte of which represents an 8 bit gray level pixel value and the pixels are arranged in an array of 512 rows and 512 columns of pixels with the first pixel value being located at the upper left-hand corner of the image and the subsequent pixels filling the array across rows and down columns.” An alternative is to append a file name extension, such as .jpg or .gif, which indicates that the data in the named file has a standard, well documented format either known to the public, or in the case of proprietary formats, to authorized users of the format. Many image formats use a combination of the file name extension and header data to provide interpretative information. For example, the .jpg format includes a header structure and the header structure has a field in which users may insert data, such as a comment, which provides even more meta-data. Some fields of header data may be necessary for the format to conform to its specification and other fields may be optional.

When an application program is written, such as a program to display a .jpg image on a computer screen, the program may be written to ignore optional data in a header. An application program may still properly display the .jpg image, even if it does not use the optional data to display the image. Image data formats which include header field(s) for data that are not required for use by an application program so it generates an image that conforms to the format specifications, are termed herein as commentable formats. The element of commentable formats that is important for the invention is that it provides a mechanism for a program to insert and make use of reasonably large data strings without interfering with the proper interpretation of the formatted data by another, independent program which cannot parse or use the data strings. Although exemplary image data is discussed herein, those skilled in the art will immediately understand that the appended header may be replaced by any mechanism which provides a documented place for meta-data and that such formats include formats for video and audio data, 3-dimensional data such as for CAT-scans, computer graphic data, virtual reality data, and such other forms of data that have commentable formats.

There are many methods that relate to the use of source and derivative images. For example, the Open Prepress Interface (“OPI”) specifies a mechanism for a user of a reduced size version (derivative) of a high quality original digital image (source) within compliant document creation programs to move the derivative image around in the document (for example, for placement purposes) and then send the document, which includes a file pointer to the source image, to a printer. The printer then replaces the derivative image with the source image in the printed output. However, such methods do not include information as to how the derivative image was generated from the source image and the file pointer is not universal but specific to a particular file system.

There are many well known aspects to the management of digital data. One task may be to erase all digital data that have not been read or altered for a year and such tasks may be done efficiently. However, there are many valuable image management tasks which relate to the relationship of source and derivative images that cannot now be done efficiently. For example, one of the most popular methods of generating images for the World Wide Web involves the use of Adobe's Photoshop program. Inside Photoshop, images are created in layers with, for example, one layer being a background photo (layer 1), another layer being an inset photo of a sports star (layer 2), another layer being a marketing brand icon (layer 3), another layer being a photo of a product (layer 4) and another layer being text (layer 5). A photo appearing on the Internet may consist of all layers superimposed on the previous one. One source-derivative data management task may be, for example, to replace all old brand icons appearing on such web images with new brand icons. Currently, except for looking (whether it is done by a person or by a computer image processing program) at every image on every web site (this approach is called the method of exhaustive search), there is no method for completing such a data management task. The method of exhaustive search, carried out by humans, is feasible only on small networks. However, there are not enough people to carry out an exhaustive search on the Internet within a time period that renders such a search useful to people and corporations. The method of exhaustive search, as carried out by computers, is only feasible when one imposes very restrictive conditions on the derivative data sets. For example, when brand images are arbitrarily rotated, scaled and filtered, even if such transformations are limited to those enabled by the Photoshop program only, no known computer program can identify such transformed brand images as being derived from source brand images.

### SUMMARY OF THE INVENTION

In general, the invention features a method and apparatus for processing derivative data sets generated by deterministically computable methods. The derivative data are managed in relationship to changes in source data or in relationship to new requirements for derivative data. For example, the derivative image data in a low resolution RGB JPEG format is appropriate for viewing on a computer monitor. If it becomes necessary to print the derivative data set on a different output device, the apparatus can generate a new, but similar, derivative data set from the source data that matches the resolution and color properties of the new output device.

In general, in one aspect, the invention features a data management system, including a process that contains a first data set, a first server associated with the process, the server including a processing engine, wherein the engine is adapted to process the first data set to form a second data set, a storage medium adapted to receive the second data set; and a second server adapted to distribute the second data set. The second server is not necessary for distribution of the second data set, and this could be one physical server. The entire system (repository, databases, transform engine and client applications) can be implemented on a single Windows PC.

In an implementation, the system includes a first database having at least one data structure associated with the first data set and a second database having at least one data structure associated with the second data set.

In another implementation, the system includes a data attachment associated with the second data set that identifies the second data set as a derivative of the first data set.

In still another implementation, the first and second data sets are images.

In another aspect, the invention features a method of managing data, including locating a first data set, e.g. an image, and transforming the first data set, e.g. an image into a second data set, while maintaining the first data set and processing the data set or image for use on a network.

In an implementation, locating the first data set, e.g. an image, includes searching for locating data associated with the first data set and retrieving the first data set based on the locating data.

In another implementation, transforming the first data set includes associating a tag with the second data set that identifies the second data set as a derivative of the first data set.

In another implementation, the tag is embedded in the second data set or attached to the second data set.

In another aspect, the invention features a data management method, including providing a first source data repository having at least one source data set, providing access to at least one user to the first source data repository, forming one additional data repository having a subset of source data from the first data repository, wherein the subset of data is provided from the user, receiving requests from the user in the additional data repository to form derived data sets from the subset of source data, selectively processing the requests and forming derived data sets in response to the requests.

In an implementation, selectively processing the requests includes determining whether the user is authorized to access the additional data repository, allowing the user access to the additional data repository if it is determined that the user has authorization and alternatively allowing the user to access the data repository. In another implementation, the method includes determining whether source data in the data repository that corresponds to the subset of data can be accessed by the user.

In still another aspect, the invention features a repository or database containing original or source image data set(s), a processing engine capable of applying a sequence of one or more computationally deterministic transformations to one or more of the original data sets, producing a secondary or derivative image data set(s), a process whereby a GUID (globally-unique identifier) is produced and associated with each derivative image data set generated through the process, a derivative data database containing a record of each transformation sequence so that a pointer to the source image data set, and the sequence of transformations and all parameters describing each transformation are stored with the associated GUID, a process that, given only a GUID, can retrieve the transformation sequence stored in database and reinitiate process to regenerate exactly the associated derivative image data set originally produced in process, or given alternate parameters for any element of the transformation sequence originally used in process, can initiate process using a modified transformation sequence to produce a new derivative image data set.

In an exemplary implementation, the system maintains multiple revisions of original source image data sets so that the specific revision of the source image data used in a particular process are recorded in (each record of) the derivative data database, so that if given a GUID associated with a derivative data set is produced from an old revision of a source data set, the system can either reproduce the derivative data set exactly from the old revision of the source data set(s) or produce a new and unique derivative data set using the same sequence of transformations recorded in the derivative data database, but starting with the now current source data set.

In another implementation, the system records additional data concerning the derivative data set(s) in the derivative data database, such as but not limited to the intended usage for each derivative data set, an alternate or preferred source data set, combined with a corresponding transformation sequence for process, that could henceforth be used in place of the derivative data set associated with the GUID.

In another implementation, the source data set and the derivative data set are image data so that source data sets can be inserted into a process, or revised and reinserted into a process, as any common or custom image file format (JPEG, GIF, PNG, TIFF, Adobe Photoshop .PSD, Windows Bitmap, etc) and derivative image data sets can be exported to any common or custom image file format (JPEG, GIF, PNG, TIFF, Adobe Photoshop .PSD, Windows Bitmap, etc).

In still another implementation, multiple source image data sets can be combined through a sequence of transformations as in a process to produce a derivative image data set.

In another implementation, the system includes one or more networked computers so that each GUID generated by a process can be combined with the networked host name, i.e. the Internet domain name, of the computer that maintains the derived data database, and be associated with the derivative image data set as a tag and an independent networked computer, connected to a common internetwork, that obtains the derivative image data set(s) along with the associated GUID(s)+host name, can connect to the computer specified in system a and request information concerning the derivative data set, and request that replica or similar derivative data be produced by system and delivered over the internetwork.

In another implementation, all computers within the system can exchange operational data using any common network protocol such as HTTP over TCP/IP, or over a proprietary network protocol.

In yet another implementation, derivative data sets, e.g. such as but not limited to image data sets, are exported in standard image file formats, and contain the data as an “embedded tag” that exists in the following form: <tag start><tag GUID><origin server name><tag end>, where:
<tag start> and <tag end> are a fixed sequence of octets that are unlikely to occur in an image
<tag guid> has a defined format and is always the same number of octets
<server name> usually exists as a “fully qualified Internet domain name”
The total size for the sequence of <tag guid> and <server name> is limited to a finite number of octets.

So that, the tag data:
a. Are unobtrusive to applications that are unaware of the embedded tag;
b. Are easily located and validated by applications seeking the tag data;
c. Can easily be embedded in any commentable image file format; and
d. Can potentially be harmlessly appended to any image file format that does not normally allow for comments.

In another implementation, the data exists as a tag within an HTML or XML document which references the associated derivative image file in the form of a fully-qualified or relative URL (Universal Resource Locator).

In another implementation, a process searches through the contents of one or more standard web sites (most likely via HTTP), looking for standard data files, e.g. standard image files. The process then examines each data file set, e.g. image, that it finds looking for embedded tags, and records information concerning the location of each tagged derivative image in a database.

In another implementation, the system enables a user to determine the (Internet) location of each derivative image that was derived from a particular source data set. Such a system would enable an application to automatically and transparently update all known derivative images produced from old revisions of a recently updated source data set by way of a mechanism.

A system and method of the present invention uniquely identifies derivative images and determines their origin in a network environment such as the Internet. The invention generates a derivative image from the original source data and associates a tag with the new derivative image. The tag uniquely identifies the server that generated it, the source image it was derived from, and the tasks or transformations that were applied to the source image to generate the derivative. The tag typically does not contain a map of tasks that produced the derivative set, and points to a database record containing all relevant information that is needed to reproduce the derivative data set. These transformations, which include compression, scaling, indexing, and editing, take an image file in a variety of formats as an input and then provide as an output an optimally formatted, edited, enhanced version of the image.

The form of this tag logically resembles that of a URL, such as:
mbp.//mediabin.iterated.com/1ad29bf8dd121f2f3cef2c34ef1b2b3d
   where the “mbp://” represents a hypothetical protocol—although HTTP or another standard Internet protocol may be used. Also, a specific protocol for accessing the derived image data need not be specified by the tag. The “mediabin.iterated.com/” represents the host or domain that generated the derivative image. The sixteen bytes of hexadecimal data represent a universally unique identifier from which the specified host or domain controller determines or looks up the history of the image being managed in a database.

Although the preceding example represents static data embedded in a simple image file, the tag may represent the same sort of data in a different form that allows an object to be modified according to the requirements of the rendering device. The tag provides a pointer to the location of comprehensive information about the derivative image's origin.

A tag is preferably inserted into commentable derivative image data that includes pointers to the location of not only source data but to the location of the set of instructions by which the source data was transformed into the derivative data. When these addresses have the form of an Internet host name together with a GUID (global unique identifier), this method is transparent to applications operating on the data set and the local computer file system where the image and other data are stored. It is also possible that the tag data (source host name or domain name and GUID) is associated with the derivative image data set through methods other than embedding the tag in the derivative image file. For example, the tag can be included within an HTML or XML document that includes, or points to, the derivative image.

### BRIEF DESCRIPTION OF THE DRAWINGS

FIG. 1 illustrates an embodiment of a data management system;

FIG. 2 illustrates an embodiment of an operational portion of a data management system of the invention;

FIG. 3 illustrates a flow chart of an implementation of generation and placement of derivative images;

FIG. 4 illustrates another embodiment of a data management system;

FIG. 5 illustrates a flow chart of an implementation of derivative image creation and placement;

FIG. 6 illustrates a flow chart of an implementation of global derivative image updating;

FIG. 7 illustrates another embodiment of a data management system;

FIG. 8 illustrates a flow chart of an implementation of source and derivative image updating;

FIG. 9 illustrates an overview of an embodiment of a business model;

FIG. 10 illustrates a prior art attempt to modify an image;

FIG. 11 illustrates an implementation of modifying an image using the data management system;

FIG. 12 is a schematic view of a compound document comprising one or more derivative data files;

FIG. 13 is a schematic diagram of an enhanced composite application associated with or otherwise available to a user through a client computer;

FIG. 14 is an exemplary schematic view of a versioning interface for an authoring or composite application; and

FIG. 15 is a process flow diagram of exemplary creation and versioning control associated with a compound file having data file assets.

### DETAILED DESCRIPTION OF PREFERRED EMBODIMENTS

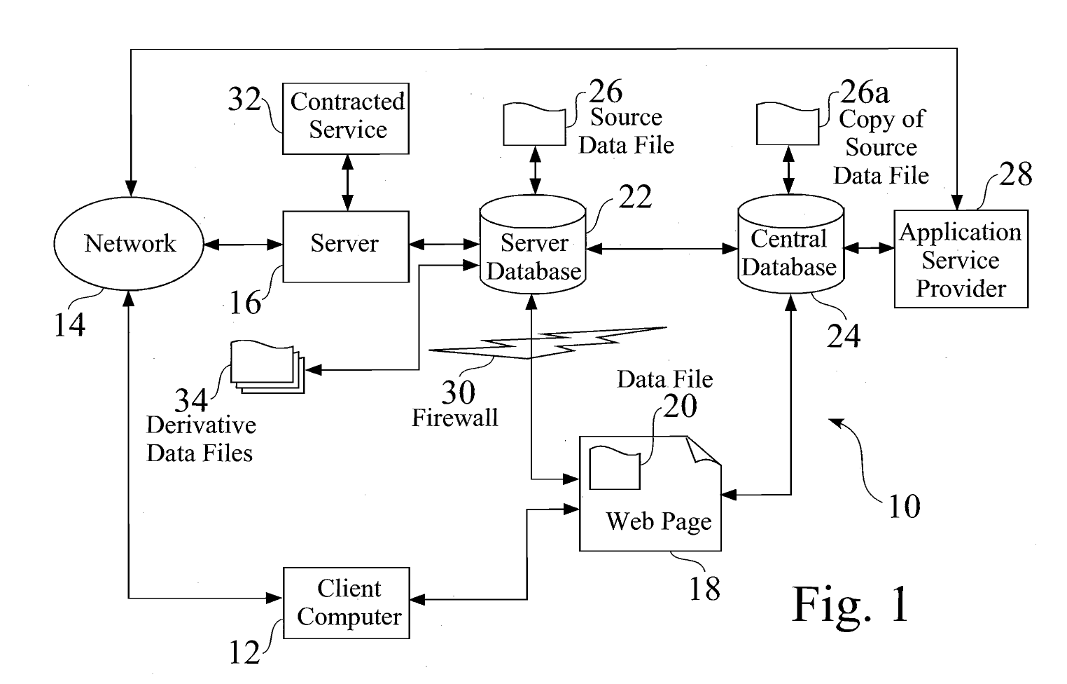

Data Management Overview. FIG. 1 illustrates an embodiment of a data management system 10. A client computer 12 is connected to a server 16 through a network 14. The client 12 can download web pages from the server 16. The requests for the web pages and the web pages themselves are delivered through network 14. In this embodiment, a web page 18 residing on the client 12 is downloaded from the server 16 and can contain numerous pieces of information from data files, such as but not limited to image file 20. In some instances, the client 12 can be related to the server 16. For example, the server 16 may be a corporate headquarters for a car manufacturer, and the client 12 may be a dealership. In such a situation, the client 12 may need access to one or more source files, such as file 20, of the web page 18. The file can be an image file, for example. The client 12 may want to access the file in order to edit it for a new application such as a print out for a flyer or for a software application to make the file 20 poster-size. If the file 20 was derived from an original source, then the file 20 is a derivative file. If the file 20 is an image file derived from a source image, then the image is a derivative image. As discussed above, the source image may have gone through several transformations to yield the derivative image.

Presently, if a client accesses a file, the file that is accessed is a web-ready file as described above. Such a file may have been modified from the original in such a way that when the file 20 is opened in an editor, much of the original information may have been lost. The information, such as resolution information, may have been lost due to any of the transformations that may have occurred to the file 20, such as by compression or reduction.

In one embodiment, the client 12 is able to access a file 20 on the web page 18 for editing. However, if the client 12 desires to edit the file in some way, the client is able to access the original source file and not the derivative file. In some instances, the client 12 can access a source file 26 directly from the server's database 22. This access is possible if the server 16 had given prior authorization to the client 12 to access the database 22. However, the client 12 may not have been given this authorization and may encounter a firewall 30 when the client 12 tries to access the database 22. In this situation, the client can attempt to access a central database 24 that has a copy 26a of the source file 26. The central database 24 is connected to an application service provider 28. This application service provider 28 provides a process 32 to servers such as server 16 that allows access to source files, so that original files can be edited for new derivative images, rather than using derivative images to make new derivative images, therefore losing information in preceding transformations. In some situations, the client 12 may not even be able to access the copy 26a of the source file 26 from the central database 24. In this situation, the client 12 has no access rights or authorization to the source file 26.

There are several other situations in which a client 12 may want to access the source file 26 instead of the derivative file 20. For example, if the derivative file 20 is an image, the client 12 may want to print the image to a printer. If the client prints the derivative image that is web-ready, the print out may be distorted because the image was not properly transformed to match the characteristics for a printer. Therefore, the client 12 can access either the server database 22 or the centralized database 24 for the source image and create a new derivative image (different from the derivative file 20) that is compatible with the printer.

The existence of a centralized application service provider 28 allows a central location for source images for several unrelated servers. This centralized location allows servers such as server 16 as well as related clients such as client 12 to remain as thin as possible. The centralized service provider server 28 shown in FIG. 1 typically serves at least two basic functions. It initially provides the process 32 to the servers that desire to have the functionality of creating several derivative images 34 using a single source file 26. In this way a server such as server 16 can provide source image 26 access to one or more clients such as client 12, from server database 22.

Another function of the centralized server is to provide centralized database 24 access to servers such as server 16. This centralized access to database 24 allows copies of source files to reside on the centralized database.

In an implementation, the owner of server 16 can contract with the owner of the server 28 and database 24 for the process 32 and for the service that provides access to the central database 24.

In another implementation, when the client successfully accesses a source file, an authentication process is also accessed which verifies that the source file is the authentic source file associated with the derivative image that the client 12 used to access the source file. This authentication can be accomplished by use of a tag that is associated with the derivative file. A detailed description of the tag is discussed below.

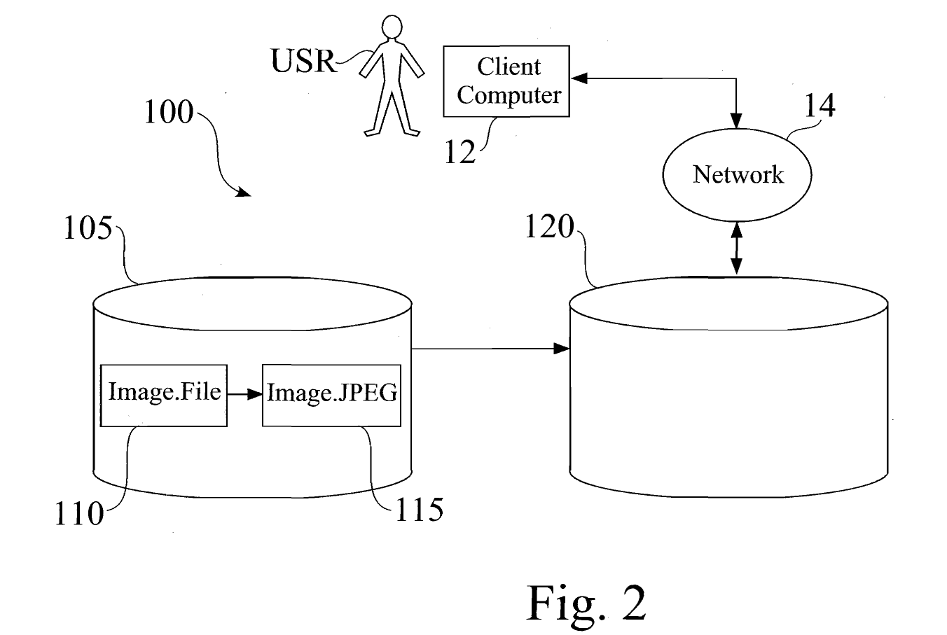

Data Management Operation. FIG. 2 illustrates an embodiment of an operational portion of a data management system 100. The system 100 is used to manage derivative image data that has been derived from source image data. A shared file system 105 can store numerous source images, each respectively associated with an image file 110. A process, which is described in detail below, can be used to transform the source image into one or more derivative images, for example an image JPEG associated with a file 115, that are web-ready. The derivative image file 115 can then be transferred to a web server 120 where it is made available to a user USR, such as accessed at a client device 12 through a network 14. The web server 120 can be a part of any network server, Local Area Network (LAN) and the like.

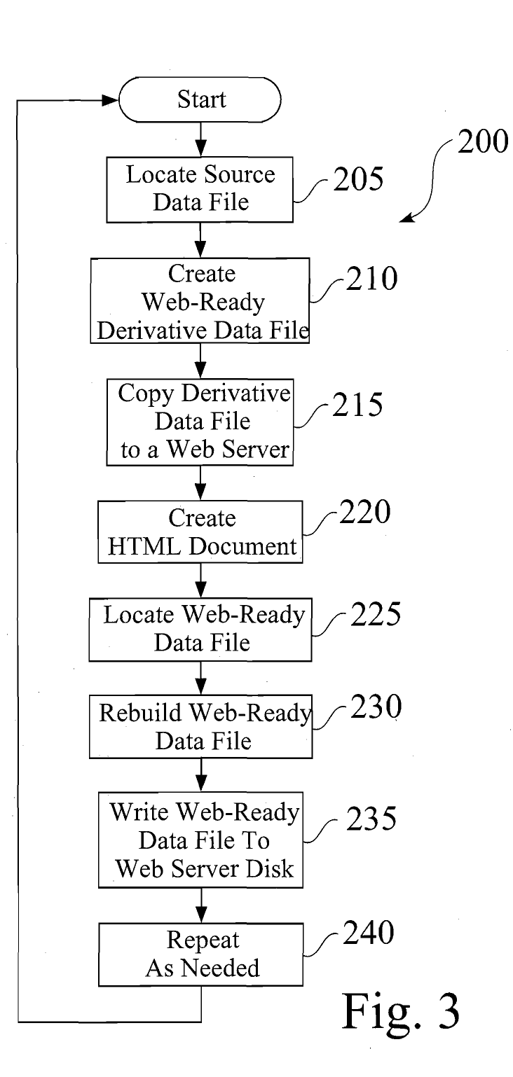

FIG. 3 illustrates a flow chart of an implementation of derivative data generation and placement process 200. The user or automatic process locates 205 a source data file, e.g. such as an image that can be of any image format, e.g. .JPG, GIF, .TRG, .BMP and the like. The system then creates 210 a web-ready derivative of the source data file or image. Typically the derivative data file is of any data file format, e.g. image format (such as .JPG) in which an embedded tag can be added to the format. In one embodiment, this embedded tag enables the process 200 to locate the source data file and recreate a similar web-ready derivative from the original source data file at a future time.

The derivative data file is copied 215 to a web server, e.g. web server 120 in FIG. 1, and a standard HyperText Markup Language (HTML) document that references the web-ready image using a standard image tag is created 220. In an implementation, a standard HTML format is used, typically like the following:
[std_web_page.html]
<p> This html page was authored using a standard HTML editor. </p>
<img src=“Image.JPEG” width=“240” height=“190”></p>
The data or image tag can specify dimensions that are different from the physical pixel dimensions of the web-ready data file or image.

The HTML is then examined to locate 225 the web-ready data file or image containing the embedded tag. The process 200 then rebuilds 230 a new web-ready data file or image from the source data file, based on the parameters of the standard HTML data file or image tag. Finally, the process 200 writes 235 the newly created web-ready data file or image to a storage location on a web server, typically overwriting the original derivative image whose physical dimensions did not match the dimensions specified by the data file or image tag. This process may be repeated 240 as necessary.

FIG. 2 and FIG. 3 describe the basic approach of the hardware and software involved with derivative data or image management. The following figures illustrate further specific embodiments of derivative data or image management.

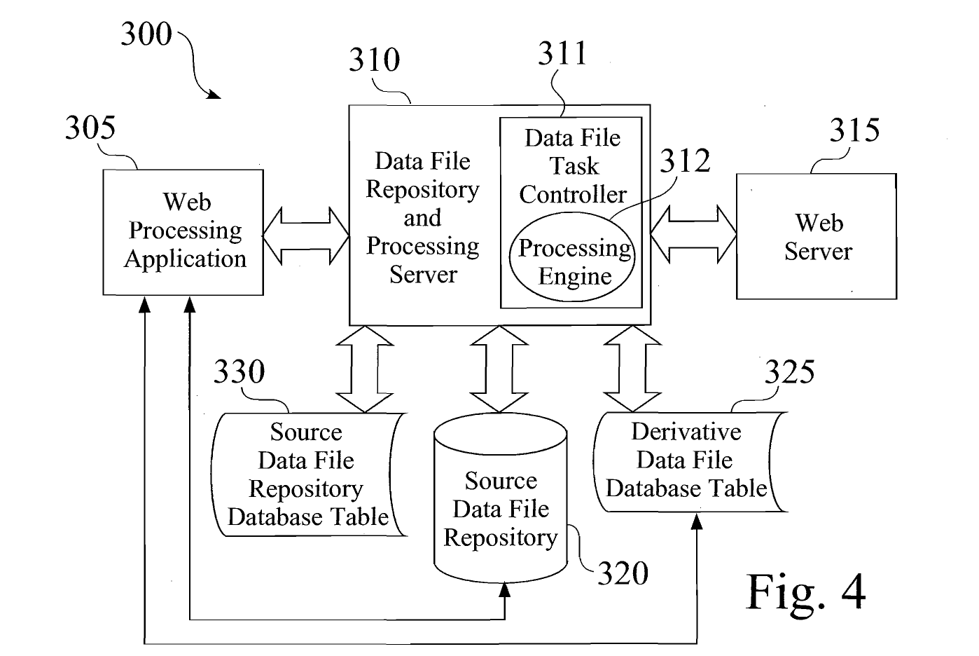

FIG. 4 illustrated another embodiment of a data management system 300. A web processing application 305 is connected to a data file, e.g. image file, repository and processing server 310. The server 310 includes a data file task controller 311 and processing engine 312. The data file task controller 311 and processing engine 312 work in conjunction to process the source data files to create new derivative data files. The data file repository and processing server 310 is connected to a web server 315 that is typically the ultimate location for the derivative data file to be distributed. The web processing application 305 is typically connected to a source data file repository database table 330 that locates source data files for use in the application 305 from the source data file repository 320 that is also connected to the data file repository and processing server 310. A derivative data file database table 325 is connected to the data file repository and processing server 310 and stores the derivative data file metadata. The derivative data file database table 325 can also be connected to the web processing application 305. The data management system 300 can contain a process for derivative data file creation and placement.

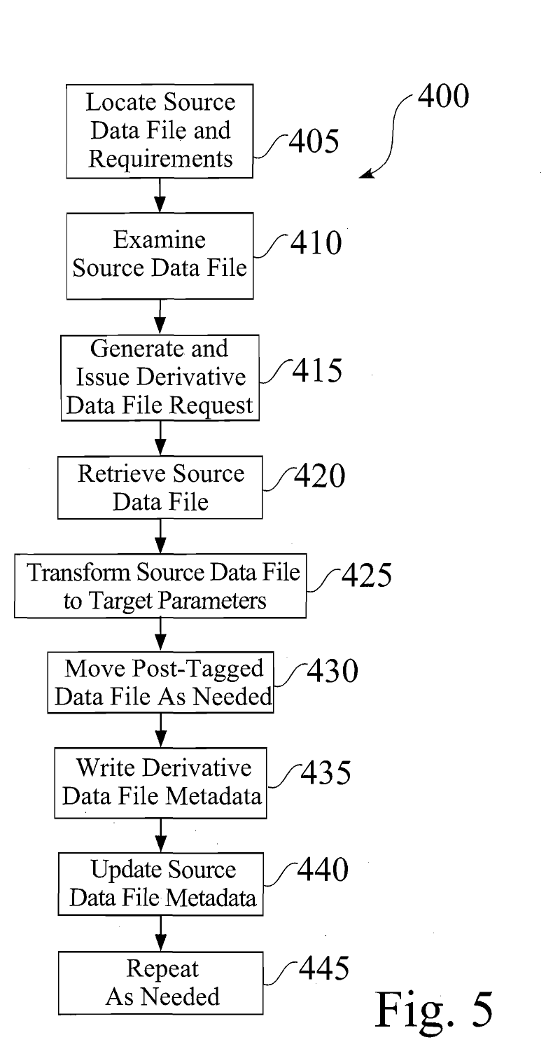

FIG. 5 illustrates a flow chart of an implementation of a derivative data file creation and placement process 400. The system 300 first examines the website and the web page to locate 405 and identify a source data file, e.g. image location and the associated requirements of that data file. Requirements typically are the needed characteristics of a derivative data file, e.g. image, for example, file format, pixel dimensions, color space and the like. Next the data file is examined 410 to select desired data file elements and layers, such as a crop region. The source location is typically determined from the source data file repository database table 330 and retrieved from the source data file repository 320 (as discussed below). The process generates and issues 415 a derivative data file request to the data file repository and processing server 310. Typically the data file request contains several elements such as, but not limited to: a source data file ID, e.g. image ID, required derivative data file attributes (image elements, color space, crop region, scale factor, file format and the like) and the derivative data file destination (Universal Resource Locator (URL) for HTTP post, file name and location, and the like).

The source data file is then retrieved 420 from the source data file repository 320. Typically, the data file data for an image embodiment is the form of pixel data. The data file is transformed 425 to the requested derivative data file parameters. In addition, the unique tag is applied and the derivative data file is created. Next the post-tagged data file is moved 430 as needed, typically to the web server 315. As mentioned above the format is an URL and updated HTML. The derivative metadata is written 435 to the derivative data file database table 325. Optionally, the source data file metadata is updated 440 to indicate that a derivative data file has been produced and written back to the source data file repository database table 330. The derivative data file database record contains a reference to the source data file and the source data file version. A report detailing which data files have been derived from a given source data file can be generated. This process can be repeated 445 as necessary. The system 300 can also be used in a global derivative data file, e.g. image, updating process.

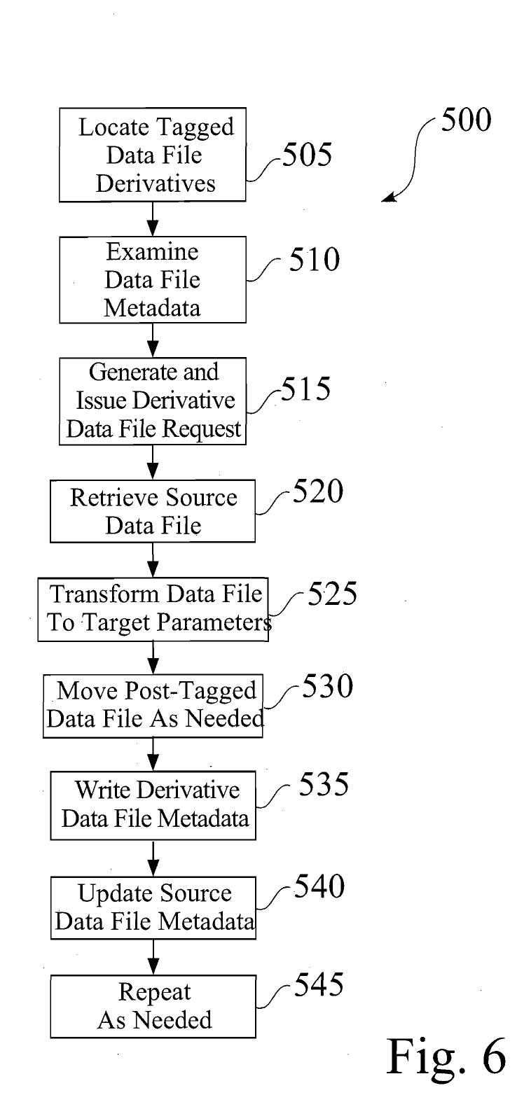

FIG. 6 illustrates a flow chart of an implementation of a global derivative data file updating process 500. This process 500 is typically used to update derivative data files that already have been tagged. The process first locates 505 tagged derivative data files, which can be located on the web server 315. The derivative data file metadata within the derivative data file database is examined 510 to determine if derivatives were created from current source data file versions. Derivative data file requests can then generated and issued 515 to update. The requests typically contain, but are not limited to the following elements: target image attributes, e.g. update derivatives, and target data file destinations (URLs for HTTP Post, filenames and locations, and the like). The source data file data is then retrieved 520 from the source data file repository 320. The data file is then transformed 525 to new derivative data file parameters, unique tags are applied and the data file derivatives are created. The post-tagged data file are moved 530, typically to URLs on the web server 315. The derivative data file metadata is written 535 to the derivative data file database table 325 and the source data file metadata is updated 540 in the source data file repository database table 330. The user can repeat 545 the process 500 as needed.

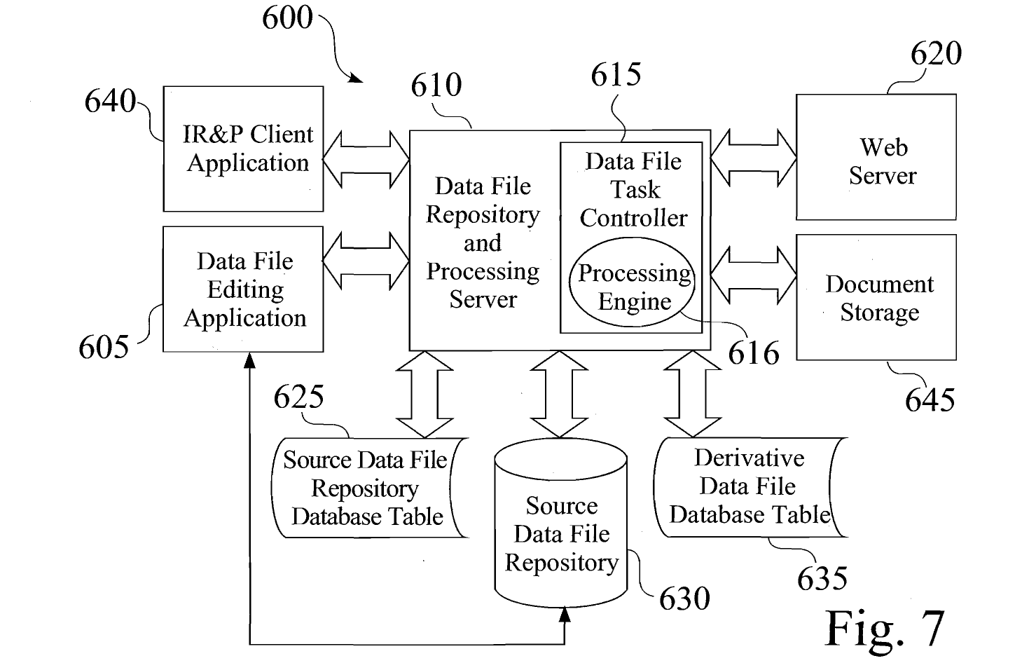

FIG. 7 illustrates still another embodiment of a data management system 600. This system 600 can be used with other derivative data file and/or image management processes (discussed below). A data file editing application 605 is associated with a data file repository and processing server 610. The data file repository and processing server 610 includes a data file task controller 615 and processing engine 616 used to process the data files. Also associated with the data file repository and processing server 610 is a data file repository and processing client application 640, which typically handles additional commands. A web server 620 is connected to the data file repository and processing server 610. A document storage unit 645 is typically a file server storage containing compound files containing tagged derivative data files. A source repository database table 625 and source data file repository 630 are connected to the data file repository and processing server 610. A derivative data file database table 635 is also connected to the data file repository and processing server 610. The system 600 can be used to update both source data files and derivative data files.

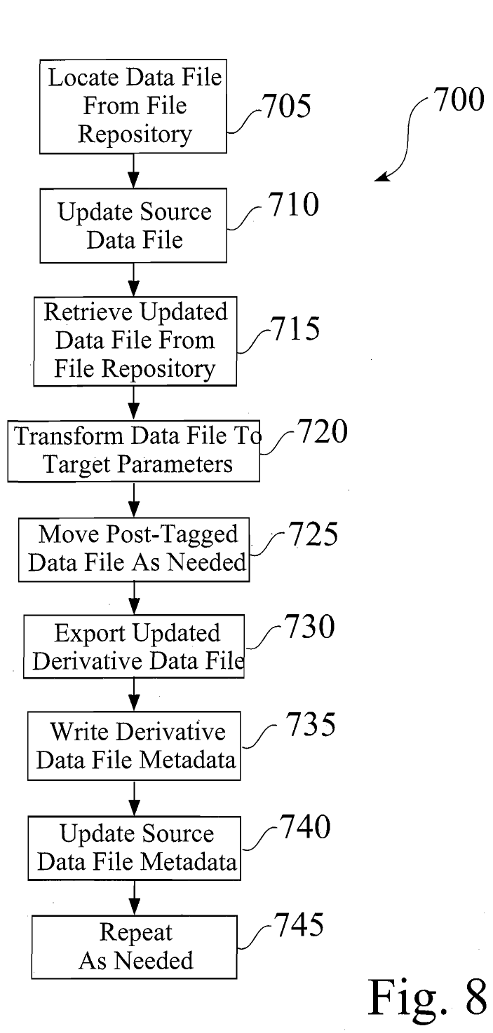

FIG. 8 illustrates a flow chart of an implementation of a source and derivative data file updating process 700. First, the process 700 browses the source data file repository 630 and retrieves 705 the data file from the repository 630. The source data file is updated 710 and checked back into the repository 630 creating a new version. The updated source data file is located in the repository 630, typically by the data file repository and processing client 640. The client 640 then issues an “update known derivatives” command and retrieves 715 the updated data file from the repository 630. The data file is transformed 720 to target parameters, wherein unique tags are applied and the derivative data file is created. The post-tagged data file is moved 725 to the URLs (as discussed above). The updated derivative data files are exported 730 to external compound files stored in the document storage unit 645. The derivative data file metadata is written 735 to the derivative data file database table 635. Finally, the source data file metadata is updated 740. This process 700 can be repeated 745 as needed.

In general, the systems and methods described above provide for applications that can transparently manage data files, such as for management of image resolution and color characteristics of image files, across numerous applications running on machines connected to a common network (such as the Internet or private intranet). For example, a plug-in, or “COM add-in” for Microsoft® Office can provide Office applications with a mechanism to connect to, browse and search a data management system server for a desirable source data file, e.g. an image, define an optional sequence of transformations and parameters (crop region, layer selections, resolution, color, filters, target file format, and the like) into a document. Each placed data file object is identified with a tag that identifies the data management server or entity that produced the data file, and a GUID.

Some preferred embodiments of the system for management of source and derivative data provide increased value for documents, such as provided in host application suites, e.g. such as but not limited to Microsoft® Office™, and/or applications, e.g. such as but not limited to Microsoft® PowerPoint™ presentations, Adobe Acrobat® portable document format (PDF) documents, Adobe PageMaker® documents, Adobe InDesign® documents, Adobe FrameMaker® documents, and Quark Xpress® documents.

For example, in a PowerPoint™ presentation document which comprises a wide variety of content, one or more included elements, such as but not limited to logos, master page templates, images, data tables, charts, music, video, animation sequences, and/or text copy, are often included at one or more points within the document. The entire PowerPoint™ document, as well as one or more of the included elements are often changed, modified or updated over time. As well, such documents and files are often sent or otherwise distributed, e.g. such as by emailing to a colleague.

In some embodiments of the system for management of source and derivative data, an enhanced PowerPoint™ file comprises means to be updated, such as if and when a corporate logo is modified. In some embodiments, the file can be manually actuated to look for one or more updated elements or components. In alternate embodiments, an enhanced application or document may provide automatic or semi-automatic updating, such on demand, at startup, on a set schedule, or by external control, e.g. corporate management control over standard templates to be used for presentations.

The originating data management server, when presented with a derivative data file GUID by a client application, can offer comprehensive information about the derivative data file, including but not limited to: source data file GUID; secondary, tertiary . . . source data file GUID(s); source data file revision(s) used to produce a derivative data file; source data file current revision(s); retrieval Task GUID (if applicable); retrieval Task contents (all transform steps with parameters); derivative data file saved to location; derivative data file creation server name (for example, server's Internet Domain Name); derivative data file creator (name of user that issues request for a derivative image); derivative data file creation date and time; derivative data file comment or intention; and alternate derivative data file GUID record, i.e. this GUID is obsolete, recommend this GUID.

The client application can also make requests for and receive new data file data, to retrieve a duplicate derivative data file, an updated derivative data file from more recent revisions of source data file(s), or to render a similar derivative data file, e.g. image for an arbitrary output device.

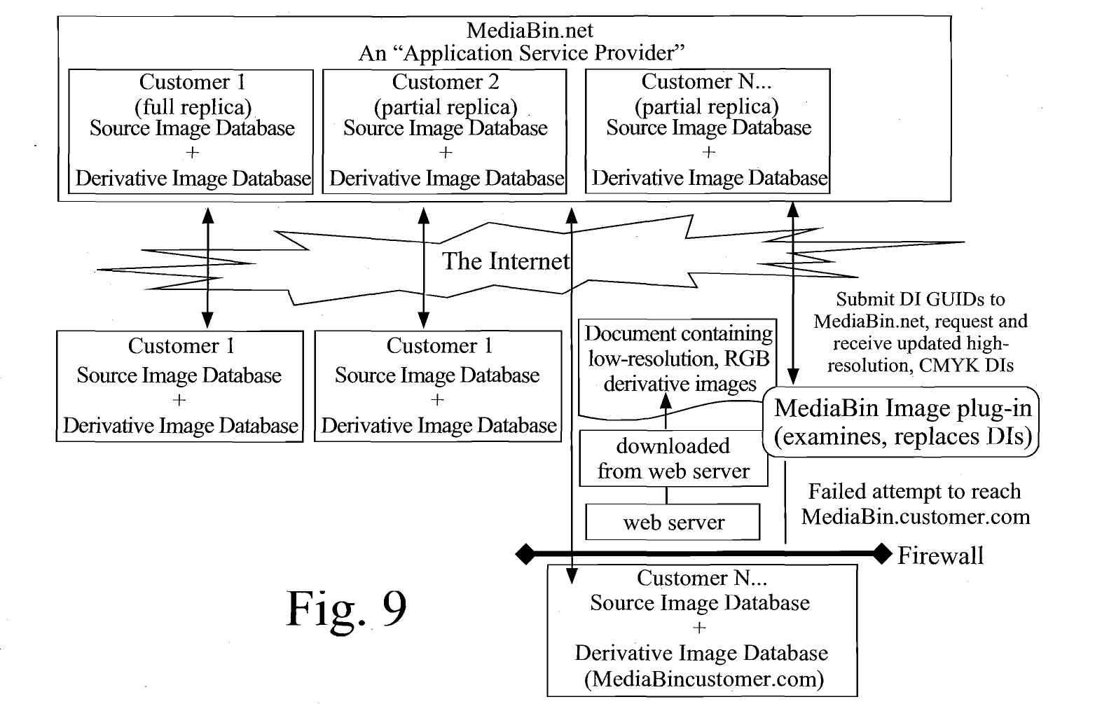

In another embodiment, as shown generally in FIG. 9, one technique allows an offer to the data management system's software licensees enabling them to establish a relationship with an ASP that provides hosting for replica data management system data and services. The ASP-hosted replica can contain both the data management system repository (source data file database: data file and metadata) and derivative data file contents. The service also offers the option of maintaining derivative data file records at a well-known host address such as: master.mediabin.net. Because each derivative data file GUID is globally unique, a query to master.mediabin.net can resolve any derivative data file GUID that has been replicated to an ASP that is associated with mediabin.net, and has been flagged to publish a “GAR” (Globally Accessible Reference) at master.mediabin.net.

Such a service can enable any number of applications, such as a COM add-in for Microsoft Office, a plug-in for Adobe Acrobat, or a stand-alone application, if having failed in an attempt to contact the host name identified by the derivative data file tag, to contact master.mediabin.net with the derivative data file GUID in question. If a globally accessible reference exists for the GUID in question, and the requesting user passes authentication requirements, then the ASP's data management system server can fulfill requests for related data file data.

Customers may indicate that modified or updated derivative data file data can be requested from master.mediabin.net by anonymous users, or they may require that users supply a digital signature or username and password. These access requirements can be determined globally or on a data file-by-data file, e.g. an image-by-image, basis.

This business model presumes that customers obtain a software license for a local data management system server, and subscribe to the hosted service. A partial list of how a customer may be charged for this service can include, but is not limited to, the following: local data management system software license fee; monthly or quarterly fee per megabyte of data maintained for them at a data management system site; and monthly or quarterly fee per data file or image transaction.

As an example of the methods and systems described above, a comparison of a prior art system to create a derivative image data file from a source image data file and of the data management system used to create a derivative image data file from a source image data file is shown. This example illustrates the value of being able to regenerate an image data file from an original source data file, rather than generating a new image data file from a derivative data file of the original source image data file, which may not include information necessary for the creation of the new derivative image data file.

As a category of web content, image data files represent a special challenge. Unlike data from conventional databases, application source code, promotional text, XML and HTML, web images cannot be directly edited and reused. The vast majority of images used on web sites are generated to meet specific size and format requirements from an original source image of another format—typically an Adobe Photoshop document that was worked with during the creative process.

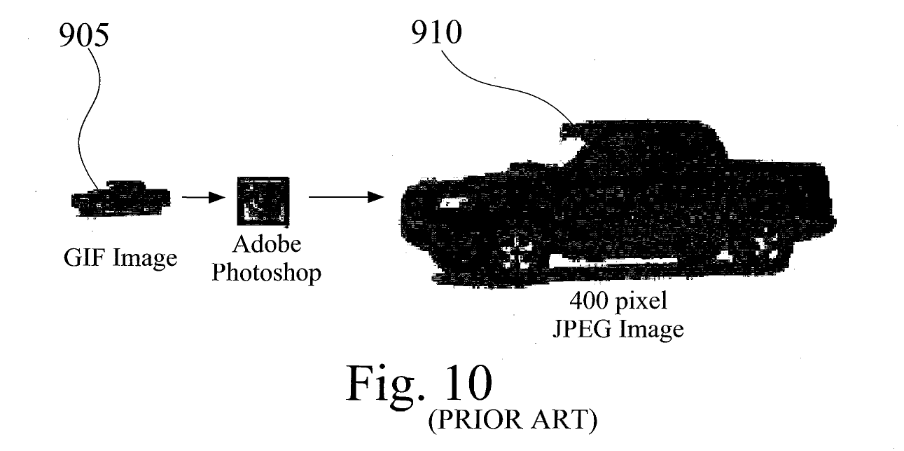

FIG. 10 illustrates a prior art attempt to modify an image data file. Presently, it is very difficult to produce a 16 million-color, 400 pixel-wide JPEG image data file starting with a 64 color, 100 pixel-wide GIF image data file (from a web page) using Photoshop. An original GIF image data file 905 is modified in Adobe® PhotoShop to produce the resulting image data file 910.

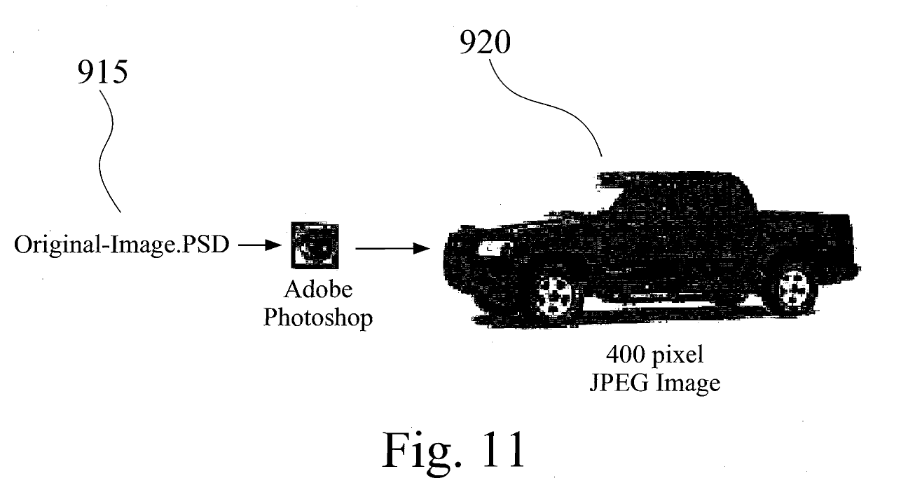

FIG. 11 illustrates an implementation of modifying an image data file using the data management system of the present invention. A derivative image data file 920 is produced from a source image data file 915 using the methods and system described above.

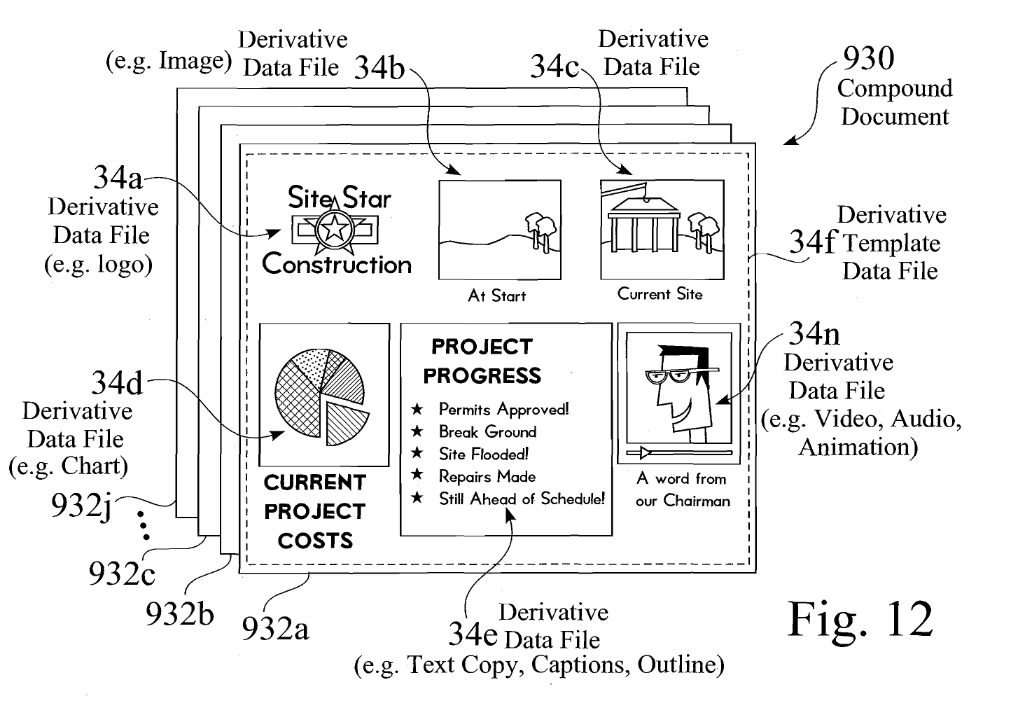

FIG. 12 is a schematic view of a compound, i.e. composite document 930. In some system embodiments, a compound document 960 is prepared through an application 942, such as but not limited to PowerPoint®. A compound document 930 typically comprises one or more pages, sheets or slides 932, such as pages 932a-932j. Each sheet or page 932, such as sheet 932a shown in FIG. 12, is often comprised of multiple elements, which often comprise derivative data files 34. The exemplary sheet 932a shown in FIG. 12 comprises a derivative logo data file 34a, one or more derivative image data files 34a, 34c, a derivative chart data file 34d, a derivative text data file 34e, an application template data file 34f, and a derivative AN file 34n, such as comprising audio, video and or animation data. The compound, i.e. composite document 930 can also comprise compound document information, such as comprising one or more sheets 932 from a source or derivative compound document 930, e.g. incorporating all or part of stored product brochure, a technical brief, and/or a sales presentation.

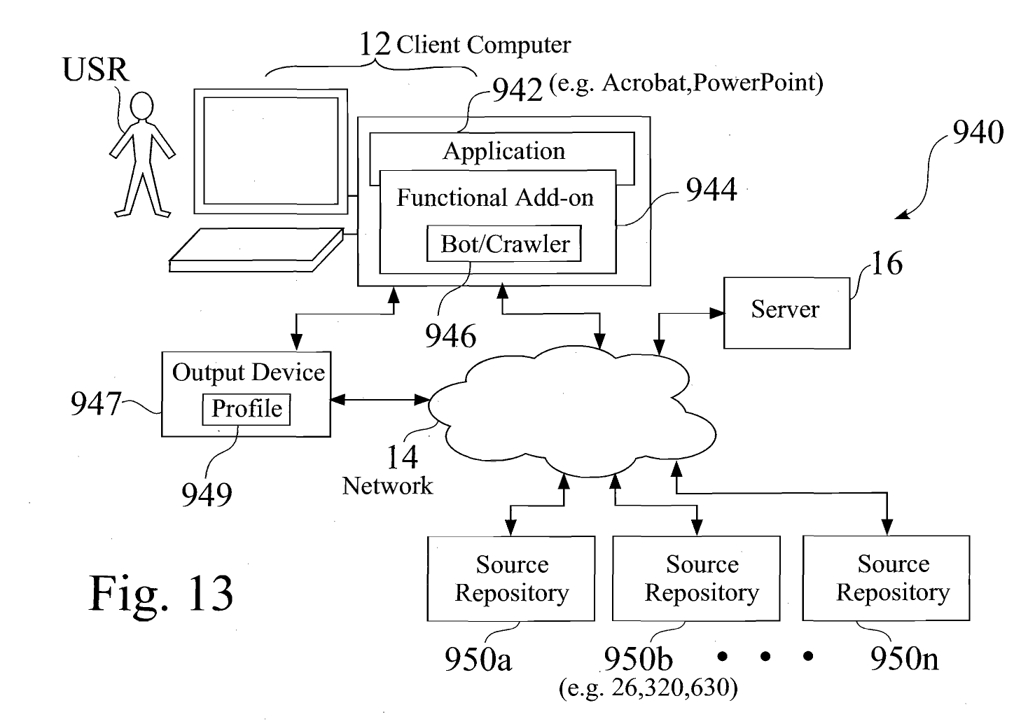

FIG. 13 is a schematic diagram of an enhanced composite application 942 associated with or otherwise available to a user through a client computer 12. The composite application 942 shown in FIG. 13 further comprises a functional add-on 944, such as a plug-in or smart client 944. In, some composite applications 942, the functional add-on 944 is an integral part of the application 942. As seen in FIG. 13, a functional add-on 944 may further comprises means 946 for searching for or otherwise finding source files 26 and/or associated processes, such as but not limited to a bot or crawler 946.

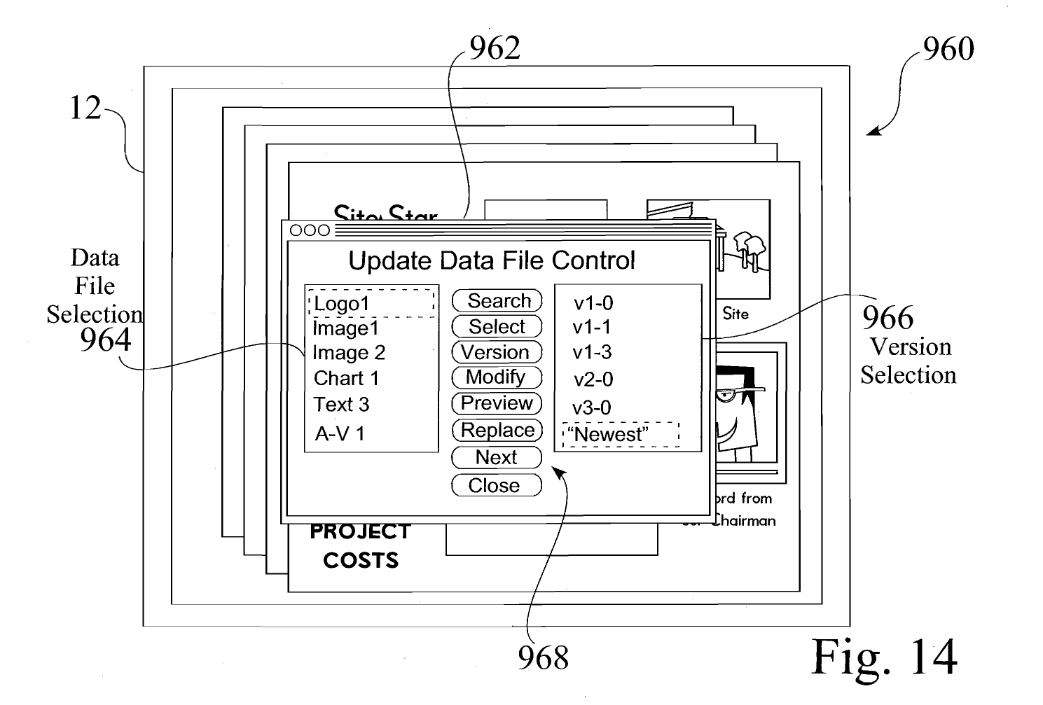

FIG. 14 is an exemplary schematic view of a versioning interface 960 for an authoring or composite application 942, such as available through or otherwise associated with an enhanced composite application 942. A data file update control interface 962 may preferably be provided, either by the user USR or automatically by the application 942, e.g. such as but not limited to a determination of updated content. The data file update control interface 962 shown in FIG. 14 comprises a data file selection interface 964, version selection 966, and interface controls 968, such as but not limited to search, selection, version, modification, preview, replacement, next/back control, and/or interface close control.

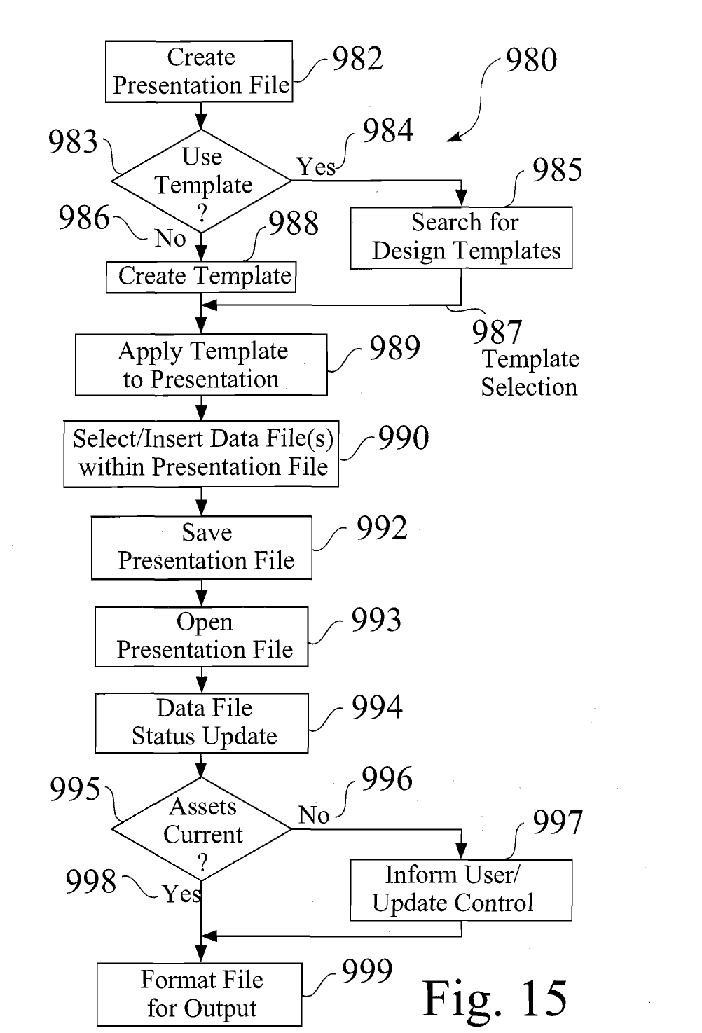

Functional Example of System Versioning. FIG. 15 is a process flow diagram 980 of exemplary creation and versioning control associated with a compound file having data file assets, such as for source data files 26 and derivative data files 34. For example, a company can use a commercial Digital Asset Management system that includes an implementation of the invention, such as a MediaBin asset-server 16, to store their “brand assets” 26,34, such as but not limited to PowerPoint® design templates, original images, logos, and/or videos, whereby the different assets are often created and/or stored in various file formats.

In the above example, all users within the company have the functional add-on 44, such as MediaBin Smart Client™ 944, which is an add-in for Microsoft Office® 942, that is integrated with the system, wherein the MediaBin Smart Client™ 944 is installed on company computers 12. The MediaBin Smart Client™ 944 allows users USR to access MediaBin 16, as a central clip gallery for Microsoft Office™ 942, which contains or otherwise accesses company-approved content 26,34.

In the example shown in FIG. 15, a user USR wants to create a sales presentation 930 within a PowerPoint® application 942 (FIG. 12). In a first step 982, such as within a Microsoft Office® PowerPoint® application 942, a user creates a new presentation file 930.

At a template selection step 983, a user USR may chose not 986 to accept a corporate standard template 34f (FIG. 12), e.g. such as manually create 988 a new template (which can preferably be later stored as an asset), or a user USR may choose 984 to optionally select a standard, i.e. approved, template 34f, such as by selecting “Format→Slide Design” from a menu. The MediaBin Smart Client™ 944 searches 985 for approved PowerPoint Design Templates 34f maintained in MediaBin, and offers one or more to choose from.

If the user selects 987 a standard template 34f, e.g. default corporate template 34f, the default corporate template 34f is downloaded from MediaBin 16, and contains the embedded tag that uniquely identifies the asset 26,34 (such as when no other data transformation(s) are applied), and the downloaded template is applied 989 to the new presentation 930.

The user USR can then locate, select and/or insert 990 one or more asset data files 34, such as by selecting “Insert→Picture→ . . . ” from a MediaBin menu 962 (FIG. 14), which searches for a particular, i.e. desired, product image 34.

In one example, a selected image 34 selected from a MediaBin 16 is a 200 MB Photoshop file, that is not only too big for a PowerPoint® (PPT) application 942 presentation, but may also be in a format that can't be read by PowerPoint 942. In such an example, the system locates the associated source image 26, which is suitably transformed into a screen-sized TIFF image 34, and placed into the presentation 930 (along with the embedded tag information).

When all data files 34 and other desired content are selected and arranged, the PowerPoint presentation 930 is complete and saved 992 for future use.

When the compound file 930 is needed, such as prior to a sales meeting, the presentation 930 is opened 993. The enhanced application 942 then preferably updates the status of any or all content 34, e.g. a MediaBin Smart Client 944 sends a Web Service message to the MediaBin server 16, wherein the host name is specified in the embedded tags, that asks if the renditions of MediaBin assets 34, e.g. the template 34f and an image data file 34 are current 998 or not 996. For example, a MediaBin server 16 can inform 997 the user USR that the design template 34f has been revised, and asks if the most recent template 34f should be applied. If the user says “OK” or otherwise selects the updated template 34f, the presentation design template is updated.

As seen in FIG. 15, a user USR may also decide to print slides 932, e.g. 932a-932j (FIG. 12) to leave with a customer, and the MediaBin Smart Client 944 asks the user USR if the images within the presentation 930 should be automatically regenerated to match the color and resolution characteristics, i.e. profile 949 (FIG. 12) of the output device 947, e.g. a target printer 947 (FIG. 12). Upon approval by the user USR, such as by selection of OK button 968 (FIG. 14), the MediaBin smart client 944 retrieves a higher-resolution image rendition 34 through or from the MediaBin server 16, that also matches the color profile 949 of a target printer 947.

In the above example, the composed compound file 930 itself may then be treated as a digital asset 26,34 within the system. For example, one or more versions of presentation files are often modified or updated, by one or more users. Within the example described above, therefore, versions of assets within the file 930 can be updated, and the entire file 930 can also be updated, e.g. such as to incorporate new pages, slides, images, and/or any other asset.

System Advantages. Most preferred embodiments of the system for management of source and derivative data insert a derivative asset tag into the actual asset. Since there is typically no online transcoding required, the enhanced derivative files can inherently be used by any application, without modification. Such an enhanced derivative data file, i.e. asset, can undergo numerous hops and deployments, and later be checked via the system database, to determine its origin, based on information included with the asset. There is therefore no online control necessary to link the derivative data assets to their corresponding source data assets, since the derivative data assets contain the necessary information, i.e. a virtual roadmap, to locate their corresponding source data and related transformations.

As well, the system for management of source and derivative data readily provides versioning or repurposing of data files, i.e. assets, whereby assets may be replaced or updated with a new version, such as for the asset itself, and/or for the transformation. In such system embodiments, the user can be prompted whether they want an up to date copy of the derivative data file asset.

In web-based asset management, such as for media.image scaling, the system for management of source and derivative data, as described herein, does not typically require that a scaling server be placed between a web server and all associated browsers. The system for management of source and derivative data allows derivative images to be deployed in web pages anywhere, as well as to be added as a part of documents or compound files or assets, such as within Word™ documents, PowerPoint™ presentations, and/or Acrobat™ documents.

The system for management of source and derivative data typically embeds tag data within a derivative data file, in a manner compatible with the specific format, so that the tracing information remains available, without special knowledge or consideration by software dealing with the derivative data file. For example, for an enhanced derivative data file comprising a JPEG format image, the enhanced data file appears to a user as, and can be used as a standard JPEG image, even though the enhanced data file includes the tag information.

The system for management of source and derivative data allows such enhanced data assets to be tracked, such as to see if a newer original source data file exists, and to track the transformation method to see if a newer transformation exists.

As well, some embodiments of the system for management of source and derivative data allows compound documents which contain one or more enhanced data assets to be tracked, such as for versioning, i.e. renditioning, such as to see if a newer original source data files exist, to track the transformation method to see if a newer transformation exists, and preferably to provide enhanced controls to guide the versioning process. For example, a crawler or bot can be used in association with an application, such as through a an internal, e.g. a plug-in or Smart Client™, or networked module, to inform the user of out-of-date content, such as by flagging if the document includes the most up to date version of one or more content assets.

In some embodiments, the system for management of source and derivative data advantageously provides a derivative tag, that comprises both a rendition GUID and server's Internet domain name pair, which enables applications to blindly retrieve an updated rendition of a derivative data asset, such as if the task or source image has been revised. Such information may also preferably include the application of task parameters, or means by which such parameters may be found.

In view of the foregoing detailed description of preferred embodiments of the present invention, it readily will be understood by those persons skilled in the art that the present invention is susceptible to broad utility and application. While various aspects have been described in the context of HTML and web page uses and in the context of management of data files, such as image data, the aspects may be useful in other contexts as well.

Although some of the exemplary embodiments of the system for management of source and derivative data described herein in connection with image files, the apparatus and techniques can be implemented for a wide variety of data, images, files, documents, media, or any combination thereof, as desired.

Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A data management system, comprising:
a source data database containing at least one source data set;
a processing engine for performing a first process to apply of one or more computationally deterministic transformations to the source data set to produce at least one derivative data set, to generate an identifier associated with the produced derivative data set, and to embed the associated identifier within each produced derivative data set;
a derivative data database containing a record of transformations for each derivative data set and all parameters describing each of the transformations;
wherein the embedded identifier comprises means for locating the stored source data set at the derivative data database and means for retrieving said transformations and all the parameters describing each of the transformations from the derivative data database; and
a second process adapted to use the embedded identifier to retrieve the source data set and the transformations stored in the derivative data database and reinitiate the first process to generate additional derivative data for the derivative data set;
wherein the source data set used in the reinitiated process comprises any of the original source data set and at least one alternate version of the original source data set; and
wherein each of the one or more computationally deterministic transformations applied to the source data set in the reinitiated process comprises any of the corresponding original computationally deterministic transformations and at least one alternate version of the corresponding original computationally deterministic transformations.

2. The system of claim 1, wherein the second process comprises an instruction to direct the first process to regenerate the derivative data set originally produced in the first process and associated with each of the source data sets.

3. The system of claim 1, wherein the second process comprises an instruction to initiate the first process using a modified transformation sequence to produce a new derivative data set, wherein the second process uses alternate parameters for any element of a transformation sequence originally used in the first process.

4. The system of claim 1, wherein the source data database maintains multiple revisions of each of the source data sets, wherein the specific revision of each of the source data sets used in the first process is recorded in the derivative data database.

5. The system of claim 4, wherein the second process is adapted to reproduce the derivative data set exactly from the old revision of one of the source data sets, using the embedded identifier.

6. The system of claim 4, wherein the second process is adapted to produce a new and unique derivative data set using the same transformations recorded in the derivative data database applied to a new current source data set.

7. The system of claim 1, wherein the derivative data database is adapted to record additional data concerning the source data sets.

8. The system of claim 7, wherein the additional data is the intended usage of the derivative data sets.

9. The system of claim 7, wherein the additional data is an alternate source data set combined with a corresponding transformation sequence for the first process that can be adapted to be used in place of the source data set associated with the identifier generated by the first process.

10. The system of claim 1, wherein the source data set is adapted to be inserted into a common image file format and the derivative data set can be exported to the common image file format.

11. The system of claim 1, further comprising:
at least one networked computer, wherein each embedded identifier is combined with a name associated with the networked computer to generate a tag associated with each of the derivative data sets; and
an independent networked computer, connected to a common network, that obtains the derivative data sets along with the associated, tags and that communicates with each of the networked computers, requests information concerning the derivative data sets, and request that a replica derivative data set be produced and delivered over the network.

12. The system of claim 11, wherein each of the derivative data sets, exported in common image file formats, contain the tag embedded in the derivative data set.

13. The system of claim 11, wherein the tag exists within a document which references the associated derivative data set in the form of a universal resource locator (URL).

14. The system of claim 11, further comprising a process having instructions to:
search through the contents of one or more standard web sites looking for standard data files;
examine each data file that it finds looking for embedded tags; and
record information concerning the location of each tagged derivative data file in a database.

15. The system of claim 1, wherein the location of each derivative data set that was derived from a particular source data set is determined, and wherein all associated derivative data files of the corresponding derivative data set produced from old revisions of a recently updated source data set are automatically and transparently generated and stored in the derivative data database.

16. A data management system, comprising:
a process that contains a source data set;
a first server associated with the process, the server including a processing engine, wherein the engine processed the source data set to form a derivative data set, to generate an identifier associated with the formed derivative data set, and to embed the associated identifier within each formed derivative data set;
a storage medium for receiving the derivative data set;
a second server for distributing the derivative data set;
a first database having at least one data structure associated with the source data set; and
a second database having at least one data structure associated with the derivative data set and having data that identifies the second data set as a derivative of the source data set;
wherein the identifier embedded within the formed derivative data set comprises:
means for locating the at least one data structure associated with the source data set; and
means for retrieving the process through which the source data set formed the derivative data set.

17. A method for managing data, comprising the steps of:
providing a source data repository having source data sets;
providing access to at least one user to the source data repository;
forming one additional data repository having a subset of the source data sets from the source data repository, wherein the subset of the source data sets is provided from the user;
receiving requests from the user in the additional data repository to form derivative data sets from the subset of the source data sets;
selectively processing the requests; and
forming derivative data sets in response to the requests, comprising the steps of:
applying one or more computationally deterministic transformations to each of the requested source data sets to form each derivative data set;
generating identifiers each uniquely associated with each formed derivative data set; and
embedding each of the associated identifiers with their corresponding formed derivative data set;
wherein each of the embedded identifiers comprises means for performing the steps of:
locating the requested source data set that corresponds to the corresponding formed derivative data set, and means for locating the sequence of computationally deterministic transformations applied to the requested source data set that corresponds to the corresponding formed derivative data set.

18. The method of claim 17, wherein the step of selectively processing the requests comprises the steps of:
determining whether the user is authorized to access the additional data repository;
allowing the user access to the additional data repository if it is determined that the user has authorization; and
alternatively allowing the user to access the data repository.

19. The method of claim 17, further comprising the step of:
determining whether the source data set in the data repository that corresponds to the subset of the source data set can be accessed by the user.

20. An enhanced data asset, wherein the enhanced data asset is formed by a process performed on a source data set, the enhanced data asset comprising:
means for locating at least one data structure associated with the source data set; and
means for retrieving the process through which the source data set formed the derivative data set.

21. A compound document, comprising:
at least one enhanced data asset formed by a process performed on a source data set, wherein the enhanced data asset comprises an embedded identifier comprising means for locating the source data set that corresponds to the corresponding formed enhanced data set, and means for locating the process by which the enhanced data set was formed; and
means for any of retrieving and locating any of the source data set and the process for a corresponding enhanced data asset, based on the embedded identifier.

22. A process implemented on a computer system, comprising the steps of:
creating a presentation file on the computer system;
integrating at least one enhanced data asset within the presentation file, the at least one enhanced data asset formed by a process performed on a source data set, wherein the enhanced data asset comprises an embedded identifier comprising means for performing the steps of locating the source data set that corresponds to the corresponding formed enhanced data set, and for locating the process by which the enhanced data set was formed; and
providing any of retrieving and locating any of the source data set and the process for a corresponding enhanced data asset, based on the embedded identifier.

23. The process of claim 22, wherein the presentation file comprises any of a PowerPoint® file and an Acrobat™ file.

24. The process of claim 22, wherein the at least one of the enhanced data assets comprises any of a template, an image, a logo, an image, an illustration, text information, audio information, video information, animation information, chart information, and compound document information.
